(19) United States
(12) Patent Application Publication
(10) Pub. No.: US 2009/0033144 A1
(43) Pub. Date: Feb. 5, 2009

(54) BRAKE APPARATUS

(75) Inventor: Junichi IKEDA, Tokyo (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/182,693

(22) Filed: Jul. 30, 2008

(30) Foreign Application Priority Data
Jul. 31, 2007 (JP) 2007-198737

(51) Int. Cl. B60T 13/66

(52) U.S. Cl. 303/20

(57) ABSTRACT

A brake apparatus includes a master cylinder hydraulically connected to a wheel cylinder, and a booster hydraulically connected between the master cylinder and the wheel cylinder. The master cylinder includes: a first pressure chamber arranged to output brake fluid in accordance with manipulation of an input device, and hydraulically connected to a wheel cylinder; and a second pressure chamber arranged to output brake fluid in accordance with the manipulation of the input device. The booster includes: a booster cylinder; a booster piston movably mounted in the booster cylinder, the booster piston dividing an internal space of the booster cylinder at least into a boost pressure chamber and a back pressure chamber, the boost pressure chamber being hydraulically connected to the wheel cylinder, the back pressure chamber being hydraulically connected to the second pressure chamber; and an electric actuator arranged to actuate the booster piston.

### BACKGROUND OF THE INVENTION

The present invention relates generally to a brake apparatus for a vehicle such as a two-wheeled vehicle, and particularly to a brake apparatus provided with a booster.

Japanese Patent Application Publication No. 9-030387 discloses a brake control system for a four-wheeled vehicle. The brake control system includes a brake control actuator hydraulically connected between a master cylinder and a wheel cylinder for boosting a wheel cylinder pressure above a master cylinder pressure. The brake control actuator includes a cylinder, a piston movably mounted in the cylinder, and an electric motor arranged to actuate the piston.

### SUMMARY OF THE INVENTION

Some vehicles such as two-wheeled vehicles are provided with a brake system that includes a brake lever provided as an input device at a right handle, and manipulated by hand to brake a front wheel through a master cylinder and a wheel cylinder. Since such brake levers are designed and adapted for hands, the brake levers are generally constructed to receive a limited amount of work based on a limited manipulating force and a limited stroke, and allow brake fluid to be supplied to in accordance with the limited amount of work.

Suppose such a brake system is provided with a booster for supplying an amplified amount of brake fluid to the wheel cylinder, such as a brake control actuator disclosed in Japanese Patent Application Publication No. 9-030387. The brake system may encounter a problem that when the brake control actuator is failed, the brake system requires a larger amount of manipulation of the brake lever in order to produce a certain wheel cylinder pressure than when the brake control actuator is normal. The brake lever may be requested to swing beyond a stroke end. The stroke end thus limits the maximum possible wheel cylinder pressure and the resulting braking force to a relatively low level.

In view of the foregoing, it is desirable to provide a brake apparatus for a vehicle such as a two-wheeled vehicle which is provided with a booster for boosting a wheel cylinder pressure, and is capable of producing a suitable braking force with a limited amount of manipulation of an input device such as a brake lever, even when the booster is failed.

According to one aspect of the present invention, a brake apparatus comprises: a master cylinder including: at least one piston; a first pressure chamber arranged to output brake fluid in accordance with travel of the at least one piston; and a second pressure chamber arranged to output brake fluid in accordance with the travel of the at least one piston; a booster including: a booster cylinder; a booster piston movably mounted in the booster cylinder, the booster piston dividing an internal space of the booster cylinder at least into a boost pressure chamber and a back pressure chamber; and an electric actuator arranged to actuate the booster piston; a first fluid passage section hydraulically connecting the first pressure chamber of the master cylinder and the boost pressure chamber of the booster cylinder to a wheel cylinder; and a second fluid passage section hydraulically connecting the second pressure chamber of the master cylinder to the back pressure chamber of the booster cylinder.

According to another aspect of the present invention, a brake apparatus comprises: a master cylinder including: a first pressure chamber arranged to output brake fluid in accordance with manipulation of an input device, and hydraulically connected to a wheel cylinder; and a second pressure chamber arranged to output brake fluid in accordance with the manipulation of the input device; and a booster including: a booster cylinder; a booster piston movably mounted in the booster cylinder, the booster piston dividing an internal space of the booster cylinder at least into a boost pressure chamber and a back pressure chamber, the boost pressure chamber being hydraulically connected to the wheel cylinder, the back pressure chamber being hydraulically connected to the second pressure chamber; and an electric actuator arranged to actuate the booster piston.

### BRIEF DESCRIPTION OF THE DRAWINGS

FIG. 1 is a schematic diagram showing a configuration of a brake apparatus according to a first embodiment of the present invention.

FIG. 2 is a schematic diagram showing an operation of the brake apparatus according to the first embodiment under condition that a function of boosting is active.

FIG. 3 is a schematic diagram showing an operation of the brake apparatus according to the first embodiment under condition that an electric motor is failed.

FIG. 4 is a schematic diagram showing an operation of the brake apparatus according to the first embodiment under condition that a function of ABS (Antilock Brake System) is active.

FIG. 5 is a schematic diagram showing a configuration of a brake apparatus according to a second embodiment of the present invention.

FIG. 6 is a schematic diagram showing a configuration of a brake apparatus according to a third embodiment of the present invention.

FIG. 7 is a schematic diagram showing a configuration of a brake apparatus according to a comparative example.

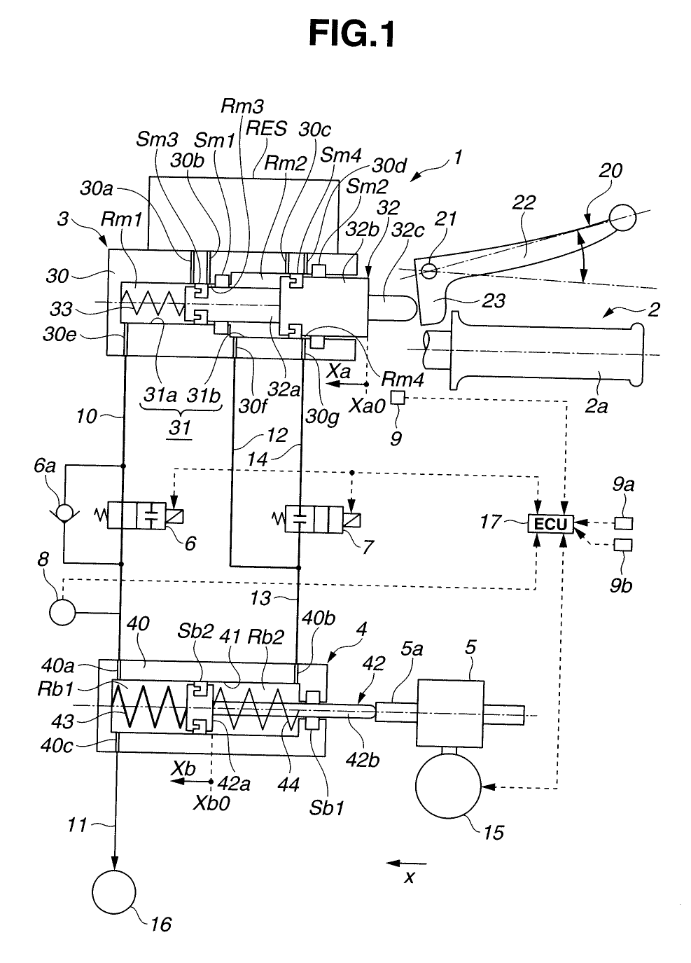

### DETAILED DESCRIPTION OF THE INVENTION

[First Embodiment, Configuration of Brake Apparatus] FIG. 1 schematically shows a configuration of a brake apparatus 1 for a two-wheeled vehicle according to a first embodiment of the present invention. In FIG. 1, brake apparatus 1 is in a default state with no manipulation of a brake lever 20 given and no braking force produced. For the following description, brake apparatus 1 is provided with an x-axis which is assumed as extending horizontally from the right to the left as viewed in FIG. 1.

Brake apparatus 1 is arranged in a brake system for a front wheel in the two-wheeled vehicle. Brake apparatus 1 includes brake lever 20, a master cylinder 3, and a booster. Master cylinder 3 operates in accordance with manipulation of brake lever 20. The booster includes a booster cylinder 4, and an electric actuator or booster actuator arranged to actuate the booster cylinder 4. Booster cylinder 4 is hydraulically arranged between master cylinder 3 and a wheel cylinder 16. Wheel cylinder 16 is a caliper of a disk brake for the front wheel in this embodiment. The electric actuator includes an electric motor 15, and a motion converter or rotation-translation converter 5.

<Brake Lever> A right handle 2 includes a throttle grip 2a having a longitudinal axis extending in the x-axis direction. Brake lever 20 is arranged to confront the throttle grip 2a, and is mounted to handle 2 for swinging motion about a pivot pin 21 as indicated by a bidirectional arrow in FIG. 1. Brake lever 20 includes a grip portion 22, and a contact portion 23. Grip portion 22 is adapted to receive a gripping force of an operator or rider, and has a longitudinal axis extending with a slight inclination to the longitudinal axis of throttle grip 2a. Contact portion 23 is connected to a positive x side longitudinal end of grip portion 22. Contact portion 23 has a longitudinal axis substantially perpendicular to the longitudinal axis of grip portion 22, and has a shorter longitudinal length than grip portion 22.

Brake lever 20 is swingably supported by pivot pin 21 which is fixed to handle 2 and located at a point where grip portion 22 meets the contact portion 23. Contact portion 23 is adapted to be in contact with a negative x side longitudinal end of an input rod 32c of a master cylinder piston 32. When brake lever 20 is gripped so that grip portion 22 swings toward the throttle grip 2a, contact portion 23 swings about pivot pin 21 in the clockwise direction as viewed in FIG. 1 and moves in the positive x-axis direction so as to press the input rod 32c in the positive x-axis direction.

<Master Cylinder> Master cylinder 3 includes a cylinder housing 30 defining a stepped in-cylinder space 31, and a stepped master cylinder piston 32 slidably mounted in in-cylinder space 31. In-cylinder space 31 includes a small-diameter in-cylinder space 31a on the positive x side and a large-diameter in-cylinder space 31b on the negative x side. Small-diameter in-cylinder space 31a has a smaller diameter than large-diameter in-cylinder space 31b. Small-diameter in-cylinder space 31a has a closed longitudinal end on the positive x side. Large-diameter in-cylinder space 31b has an open longitudinal end on the negative x side which is open to outside of cylinder housing 30. Small-diameter in-cylinder space 31a is provided with a seal ring Sm1 attached to an inner lateral periphery of small-diameter in-cylinder space 31a on the negative x side. Large-diameter in-cylinder space 31b is provided with a seal ring Sm2 attached to an inner lateral periphery of large-diameter in-cylinder space 31b on the negative x side.

Master cylinder piston 32 includes a small-diameter portion 32a, a large-diameter portion 32b, and input rod 32c, which are arranged in the negative x-axis direction in the listed order. Small-diameter portion 32a is mounted in small-diameter in-cylinder space 31a. Large-diameter portion 32b is mounted in large-diameter in-cylinder space 31b. Input rod 32c extends in the negative x-axis direction outside of cylinder housing 30. Input rod 32c includes a semispherical longitudinal end on the negative x side which is adapted to be in contact with the contact portion 23 of brake lever 20.

The small-diameter portion 32a of master cylinder piston 32 slides relative to small-diameter in-cylinder space 31a, in sliding contact with seal ring Sm1. The large-diameter portion 32b of master cylinder piston 32 slides relative to large-diameter in-cylinder space 31b, in sliding contact with seal ring Sm2. A first pressurizing chamber or pressure chamber Rm1 is defined and surrounded by the inner lateral periphery and closed longitudinal end of small-diameter in-cylinder space 31a and a positive x side longitudinal end surface of small-diameter portion 32a with a seal ring Sm3. A second pressurizing chamber or pressure chamber Rm2 is defined and surrounded by the inner lateral periphery of large-diameter in-cylinder space 31b, the outer lateral periphery of small-diameter portion 32a, and a positive x side longitudinal end surface of large-diameter portion 32b with a seal ring Sm4. Movement of master cylinder piston 32 in the positive x-axis direction pressurizes both of first pressurizing chamber Rm1 and second pressurizing chamber Rm2 so as to raise both of fluid pressures substantially simultaneously.

A return spring 33 is disposed in first pressurizing chamber Rm1, having a longitudinal end fixed to the positive x side longitudinal end of small-diameter in-cylinder space 31a, and another longitudinal end fixed to the positive x side longitudinal end of the small-diameter portion 32a of master cylinder piston 32, for biasing the master cylinder piston 32 in the negative x-axis direction. Master cylinder piston 32 is maximally displaced in the negative x-axis direction, and positioned and held in a default position Xa0 by the biasing force of return spring 33, when brake lever 20 is not manipulated.

Master cylinder 3 is provided with a stroke sensor or travel sensor 9 arranged to measure a displacement or stroke or travel Xa of master cylinder piston 32. The displacement Xa is defined as a displacement of master cylinder piston 32 in the positive x-axis direction with respect to the default position Xa0.

A reservoir tank “RES” as a fluid absorber is mounted to cylinder housing 30 for storing brake fluid. Cylinder housing 30 is formed with fluid passages 30a, 30b, 30c, 30d, 30e, 30f and 30g. Reservoir tank RES is hydraulically connected to small-diameter in-cylinder space 31a through fluid passages 30a and 30b, and hydraulically connected to large-diameter in-cylinder space 31b through fluid passages 30c and 30d. Small-diameter in-cylinder space 31a is hydraulically connected to a fluid passage 10 through fluid passage 30e, where fluid passage 10 is defined in a pipe. Large-diameter in-cylinder space 31b is hydraulically connected to a fluid passage 12 and a pressure relief passage 14 through respective ones of fluid passages 30f and 30g, where fluid passage 12 and pressure relief passage 14 are defined in respective pipes.

Fluid passage 30b is located on the positive x side of seal ring Sm1, and close to seal ring Sm1. Fluid passage 30a is located on the positive x side of fluid passage 30b, and close to fluid passage 30b. Fluid passage 30e is located close to the positive x side longitudinal end of small-diameter in-cylinder space 31a. Fluid passages 30d and 30g are located on the positive x side of seal ring Sm2, and close to seal ring Sm2. Fluid passage 30c is located on the positive x side of fluid passage 30d, and close to fluid passage 30d. Fluid passage 30f is located close to the positive x side longitudinal end of large-diameter in-cylinder space 31b.

The small-diameter portion 32a of master cylinder piston 32 includes an annular groove at a positive x side longitudinal end portion in which seal ring Sm3 is retained for liquid-tightly sealing the first pressurizing chamber Rm1. The large-diameter portion 32b of master cylinder piston 32 includes an annular groove at a positive x side longitudinal end portion in which seal ring Sm4 is retained for liquid-tightly sealing the second pressurizing chamber Rm2. A first replenishing chamber Rm3 is defined between seal ring Sm1 and seal ring Sm3, and is hydraulically connected to fluid passage 30b, for replenishing the first pressurizing chamber Rm1 with brake fluid through radially outside of seal ring Sm3, when master cylinder piston 32 is displaced back in the negative x-axis direction. A first replenishing chamber Rm4 is defined between seal ring Sm2 and seal ring Sm4, and is hydraulically connected to fluid passage 30d, for replenishing the second pressurizing chamber Rm2 with brake fluid through radially outside of seal ring Sm4, when master cylinder piston 32 is displaced back in the negative x-axis direction. Second replenishing chamber Rm4 is hydraulically connected to pressure relief passage 14.

When master cylinder piston 32 is in the default position Xa0, seal ring Sm3 is located between fluid passage 30a and fluid passage 30b in the x-axis direction. Accordingly, reservoir tank RES hydraulically communicates with first pressurizing chamber Rm1 through fluid passage 30a so as to set the internal pressure of first pressurizing chamber Rm1 equal to the atmospheric pressure. Simultaneously, seal ring Sm4 is located between fluid passage 30c and fluid passage 30d in the x-axis direction. Accordingly, reservoir tank RES hydraulically communicates with second pressurizing chamber Rm2 through fluid passage 30c so as to set the internal pressure of second pressurizing chamber Rm2 equal to the atmospheric pressure. Simultaneously, reservoir tank RES hydraulically communicates with pressure relief passage 14 through fluid passage 30d and fluid passage 30g.

Fluid passage 30b is constantly separated from first pressurizing chamber Rm1, wherever master cylinder piston 32 is located. Also, fluid passage 30d is constantly separated from second pressurizing chamber Rm2. Fluid passage 30e and fluid passage 30f constantly hydraulically communicate with fluid passage 10 and fluid passage 12, respectively, wherever master cylinder piston 32 is located. The hydraulic communication between fluid passage 30a and first pressurizing chamber Rm1, and the hydraulic communication between fluid passage 30c and second pressurizing chamber Rm2 are allowed or inhibited according to the stroke position of master cylinder piston 32.

<Booster Actuator> Electric motor 15 and rotation-translation converter 5 serves as a booster actuator for actuating the booster cylinder 4. In this embodiment, electric motor 15 is a DC brushless motor which is advantageous in controllability, quietness and tolerance. Alternatively, electric motor 15 may be an electric motor provided with brushes, or an AC motor. Rotation-translation converter 5 is arranged to convert a rotary motion of an output shaft of electric motor 15 into a translating motion in the x-axis direction. Rotation-translation converter 5 may be implemented by any mechanism such as a ball-screw mechanism or a rack-and-pinion mechanism. Rotation-translation converter 5 includes a contact portion 5a adapted to be in contact with an input rod 42b of a booster piston 42. Rotation of electric motor 15 in a normal rotational direction causes the contact portion 5a of rotation-translation converter 5 to move in the positive x-axis direction according to the amount of rotation of electric motor 15. On the other hand, rotation of electric motor 15 in a reverse rotational direction causes the contact portion 5a to move in the negative x-axis direction according to the amount of rotation of electric motor 15.

<Booster Cylinder> Booster cylinder 4 includes a cylinder housing 40 defining an in-cylinder space 41, and a booster piston 42 slidably mounted in in-cylinder space 41. In-cylinder space 41 has a negative x side longitudinal end open to outside of cylinder housing 40. The opening of in-cylinder space 41 is provided with a seal ring Sb1.

Booster piston 42 includes a slider 42a, and input rod 42b, which are arranged in the negative x-axis direction in the listed order. Slider 42a has a larger diameter than input rod 42b, and is slidably mounted in in-cylinder space 41. Slider 42a includes a groove in an outer lateral periphery in which a seal ring Sb2 is retained in sliding contact with the inner lateral periphery of in-cylinder space 41. Input rod 42b includes a positive x side longitudinal end connected to slider 42a. Input rod 42b is slidably mounted relative to cylinder housing 40 through seal ring Sb1 at the opening of cylinder housing 40. Input rod 42b has a semispherical negative x side longitudinal end extending outside of cylinder housing 40, and adapted to be in contact with the contact portion 5a of rotation-translation converter 5.

The in-cylinder space 41 of booster cylinder 4 is divided by booster piston 42 into a pair of chambers which are arranged in the x-axis direction. A first booster chamber or boost pressure chamber Rb1 is defined and surrounded by the inner lateral periphery and positive x side longitudinal end of in-cylinder space 41 and the positive x side longitudinal end of slider 42a with seal ring Sb2. A second booster chamber or back pressure chamber Rb2 is defined and surrounded by the inner lateral periphery of in-cylinder space 41, the outer lateral periphery of input rod 42b, the negative x side longitudinal end of in-cylinder space 41 with seal ring Sb1, and the negative x side longitudinal end of slider 42a with seal ring Sb2.

A hard spring 43 of a large spring constant is disposed in first booster chamber Rb1, having a longitudinal end fixed to the positive x side longitudinal end of in-cylinder space 41, and another longitudinal end adapted to be in contact with the positive x side longitudinal end of slider 42a, for biasing the booster piston 42 in the negative x-axis direction. A soft spring 44 of a small spring constant is disposed in second booster chamber Rb2, having a longitudinal end fixed to the negative x side longitudinal end of slider 42a, and another longitudinal end fixed to the negative x side longitudinal end of in-cylinder space 41, for biasing the booster piston 42 in the positive x-axis direction. Booster piston 42 is positioned and held in a default position Xb0 by the biasing forces of springs 43 and 44, at the time of no braking operation, i.e. when brake lever 20 is not manipulated, and electric motor 15 and electromagnetic valves 6 and 7 are de-energized.

Cylinder housing 40 is formed with fluid passages 40a, 40b, and 40c. Fluid passages 40a and 40c are located close to the positive x side longitudinal end of in-cylinder space 41. Fluid passage 40b is located close to the negative x side longitudinal end of in-cylinder space 41. Fluid passage 40a is hydraulically connected to fluid passage 10. Fluid passage 40b is hydraulically connected to a fluid passage 13. Fluid passage 40c is hydraulically connected to a fluid passage 11 leading to wheel cylinder 16. Brake apparatus 1 according to this embodiment thus employs the construction that in-cylinder space 41 is hydraulically arranged between fluid passage 10 and fluid passage 11, but brake apparatus 1 is not so limited. For example, brake apparatus 1 may employ an alternative construction that fluid passage 10 is hydraulically connected directly to fluid passage 11, and a pipe is provided which extends from cylinder housing 40 and hydraulically connects in-cylinder space 41 to fluid passages 10 and 11.

<Hydraulic Circuit> Reservoir tank RES is hydraulically connected to first pressurizing chamber Rm1 of master cylinder 3 through fluid passage 30a, when master cylinder piston 32 is located in the default position Xa0. First pressurizing chamber Rm1 is hydraulically connected to first booster chamber Rb1 of booster cylinder 4 through fluid passages 30e, 10, and 40a. First booster chamber Rb1 is hydraulically connected to front wheel cylinder 16 through fluid passages 40c and 11.

Fluid passage 10 is provided with a normally open electromagnetic valve 6. A check valve 6a is provided in parallel to electromagnetic valve 6 for allowing brake fluid to flow from booster cylinder 4 to master cylinder 3, and preventing brake fluid from inversely flowing from master cylinder 3 to booster cylinder 4. Fluid passage 10 is provided with a fluid pressure sensor 8 disposed on the downstream side of electromagnetic valve 6 for measuring a brake fluid pressure or wheel cylinder pressure Pw.

Reservoir tank RES is hydraulically connected to second pressurizing chamber Rm2 of master cylinder 3 through fluid passage 30c, when master cylinder piston 32 is located in the default position Xa0. Second pressurizing chamber Rm2 is hydraulically connected to second booster chamber Rb2 of booster cylinder 4 through fluid passages 30f, 12, 13 and 40b.

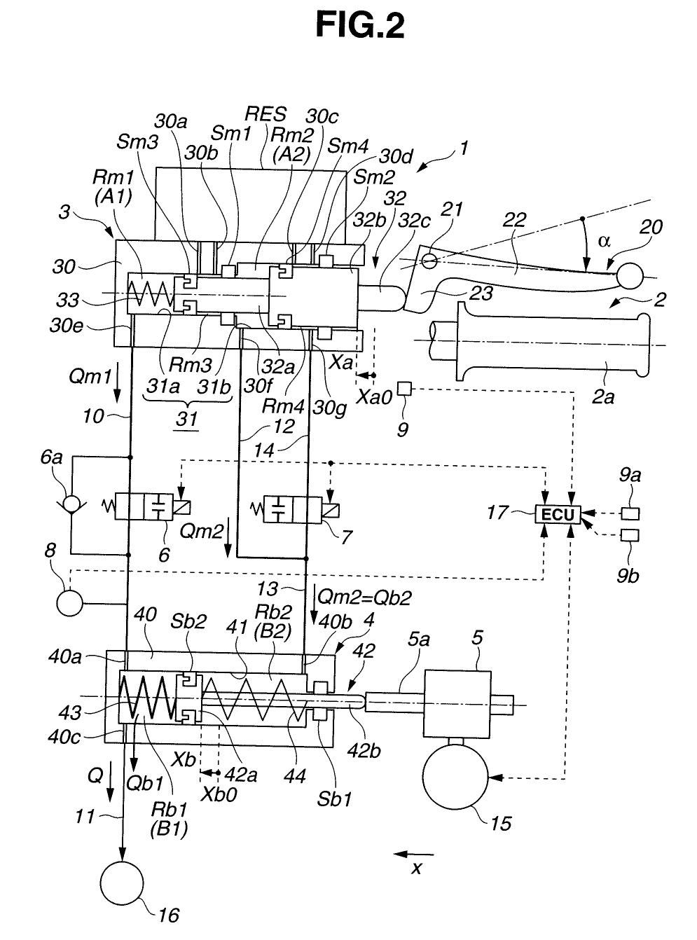

Reservoir tank RES is hydraulically connected to pressure relief passage 14 through fluid passages 30d and 30g. Pressure relief passage 14 is merged with fluid passage 12 into fluid passage 13. Pressure relief passage 14 is provided with a normally closed electromagnetic valve 7.

<Control System> Fluid pressure sensor 8, stroke sensor 9, electric motor 15, and electromagnetic valves 6 and 7 are electrically connected for signal communication to an electrical control unit or ECU 17. ECU 17 is also electrically connected for signal communication to wheel speed sensors 9a and 9b arranged to measure speeds of front and rear wheels, respectively. ECU 17 computes desired values of manipulated variables of electric motor 15 and electromagnetic valves 6 and 7 on the basis of wheel cylinder pressure Pw measured by fluid pressure sensor 8 and displacement Xa of master cylinder piston 32 measured by stroke sensor 9, and outputs control signals indicative of the desired values to electric motor 15 and electromagnetic valves 6 and 7. ECU 17 implements a function of boosting and a function of ABS by controlling the electric motor 15, and electromagnetic valves 6 and 7.

[Operation of Brake Apparatus] In the following description, A1 represents a cross-sectional area of first pressurizing chamber Rm1 of master cylinder 3 or a pressure-receiving area in the x-axis direction of first pressurizing chamber Rm1, A2 represents a pressure-receiving area of second pressurizing chamber Rm2, B1 represents a pressure-receiving area of first booster chamber Rb1 of booster cylinder 4, and B2 represents a pressure-receiving area of second booster chamber Rb2. The ratios between the pressure-receiving areas A1, A2, B1 and B2 are set so as to suitably adjust an amount of assist for stroke of master cylinder 3, i.e. the ratio of an apparent assist stroke or an apparent amplified stroke of master cylinder 3 to an actual stroke of master cylinder 3, for normal operating conditions, and for failed operating conditions. The apparent assist stroke of master cylinder 3 is defined as an apparent amount of stroke of master cylinder 3 that is equivalent to an additional amount of brake fluid supplied to wheel cylinder 16 other than the amount of brake fluid supplied from first pressurizing chamber Rm1 of master cylinder 3. The apparent amplified stroke of master cylinder 3 is defined as a sum of the actual stroke of master cylinder 3 and the apparent assist stroke of master cylinder 3. This terminology may be also applied to brake lever 20. For ease of understanding, the following description is based on an assumption that A1=A2=B1=B2.

<Function of Boosting> FIG. 2 schematically shows an operation of brake apparatus 1 for implementing a function of boosting. The function of boosting is defined as a function of assisting the stroke of master cylinder 3 by supplying brake fluid to wheel cylinder 16 independently of master cylinder 3, and thereby producing a desired wheel cylinder pressure based on a small amount of manipulation of brake lever 20.

When brake lever 20 is gripped by the rider, then master cylinder piston 32 is displaced in the positive x-axis direction by a displacement of Xa from the default position Xa0 shown in FIG. 1 where the displacement Xa is corresponding to an amount of manipulation a of brake lever 20. ECU 17 allows electromagnetic valve 7 to open, and allows electric motor 15 to rotate in the normal rotational direction so that booster piston 42 moves in the positive x-axis direction by a displacement of Xb which is equal to the displacement Xa. When electromagnetic valve 7 is opened, then second booster chamber Rb2 of booster cylinder 4 hydraulically communicates with reservoir tank RES. Accordingly, the internal pressure of second booster chamber Rb2 remains equal to the atmospheric pressure.

The displacement Xa of master cylinder piston 32 in the positive x-axis direction causes the first pressurizing chamber Rm1 to be shut off from reservoir tank RES and reduces the volumetric capacity of first pressurizing chamber Rm1 by a volume of Qm1 (Qm1=A1·Xa). Accordingly, the volume Qm1 of brake fluid is supplied from first pressurizing chamber Rm1 through fluid passage 10 to first booster chamber Rb1 of booster cylinder 4. Simultaneously, second pressurizing chamber Rm2 is shut off from reservoir tank RES, so that second pressurizing chamber Rm2 supplies a volume of Qm2 (Qm2=A2·Xa) of brake fluid through fluid passage 12 to fluid passage 13 and pressure relief passage 14.

The displacement Xb (Xb=Xa) of booster piston 42 in the positive x-axis direction causes a decrease in the volumetric capacity of first booster chamber Rb1 by a volume of Qb1 (Qb1=B1·Xb). Accordingly, first pressurizing chamber Rm1 supplies a volume of Q (Q=Qm1+Qb1) of brake fluid, as a sum of the volume Qb1 (Qb1=B1·Xb) and the volume Qm1 (Qm1=A1·Xa) of brake fluid supplied from first pressurizing chamber Rm1, through fluid passage 11 to wheel cylinder 16.

On the assumption of A1=B1 and Xa=Xb, it is obtained that Qm1 is equal to Qb1, and Q=Qm1+Qb1=2Qm1=2(A1·Xa). The volume Q is twice a volume corresponding to the amount of manipulation a of brake lever 20 (displacement Xa of master cylinder piston 32). The function of boosting thus produces an effect of doubling the stroke or displacement of master cylinder 3 (Q=A1·2Xa) so as to increase the rate of increase of wheel cylinder pressure Pw. In other words, as compared to a reference brake system provided with no function of boosting, the pressure-receiving area A1 of small-diameter portion 32a of master cylinder piston 32 may be half that of the reference brake system, in order to supply the volume Q or the wheel cylinder pressure Pw to wheel cylinder 16 in response to the amount of manipulation a of brake lever 20.

The displacement Xb (Xb=Xa) of booster piston 42 in the positive x-axis direction also causes an increase in the volumetric capacity of second booster chamber Rb2 by a volume of Qb2 (Qb2=B2·Xb) so that the volume Qb2 of brake fluid is supplied to second booster chamber Rb2 through fluid passage 13. The assumption of A2=B2 and Xa=Xb yields Qb2=Qm2. Accordingly, the volume Qm2 of brake fluid supplied through fluid passage 12 from second pressurizing chamber Rm2 flows into second booster chamber Rb2 through fluid passage 13. Therefore, the volume of brake fluid supplied from reservoir tank RES through electromagnetic valve 7 or returned to reservoir tank RES through electromagnetic valve 7 is small.

The internal pressure of first pressurizing chamber Rm1 is equal to wheel cylinder pressure Pw. In no consideration of the biasing force of return spring 33, master cylinder piston 32 is subject to a force of Fm1 (Fm1=Pw·A1) acting in the negative x-axis direction from first pressurizing chamber Rm1. Master cylinder piston 32 is subject to no force (Fm2=0) acting in the positive x-axis direction from second pressurizing chamber Rm2, because the internal pressure of second pressurizing chamber Rm2 is equal to the atmospheric pressure. In summary, brake lever 20 is subject to a force of Fm acting in the negative x-axis direction from master cylinder piston 32 (Fm=Fm1+Fm2=Pw·A1). The force Fm produces a feedback force applied to the rider through brake lever 20, where the feedback force is proportional to wheel cylinder pressure Pw or braking force. When the pressure-receiving area A1 of small-diameter portion 32a of master cylinder piston 32 is set half that of the reference brake system with no function of boosting, then the manipulating force of brake lever 20 is half that of the reference brake system. This means that an amplification factor is equal to 2.

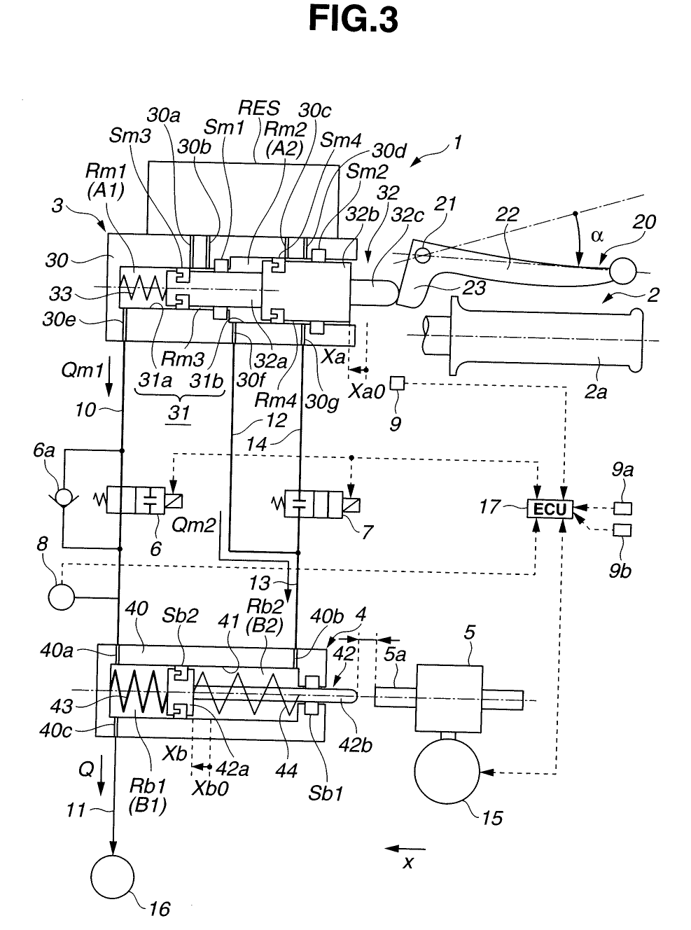

FIG. 3 schematically shows an operation of brake apparatus 1 under condition that the booster actuator (electric motor 15, rotation-translation converter 5) is failed. In FIG. 3, electric motor 15 is failed so that the contact portion 5a of rotation-translation converter 5 is held maximally displaced in the negative x-axis direction.

When a failure or malfunction occurs under condition that electromagnetic valve 7 is opened as shown in FIG. 2, then booster piston 42 is allowed to move in the negative x-axis direction so that no brake fluid is supplied from first booster chamber Rb1 to wheel cylinder 16 (Qb1=0). Moreover, part or all of the volume Qm1 of brake fluid supplied from first pressurizing chamber Rm1 of master cylinder 3 is absorbed in first booster chamber Rb1, because the volumetric capacity of first booster chamber Rb1 is allowed to increase. As a result, the volume of brake fluid supplied to wheel cylinder 16 is smaller than Qm1.

In order to prevent the above phenomenon, when detecting that the value of wheel cylinder pressure Pw measured by fluid pressure sensor 8 is lower than under normal operating conditions, then ECU 17 stops to output the drive signal to electric motor 15, and outputs a control signal to electromagnetic valve 7 so as to allow electromagnetic valve 7 to close as shown in FIG. 3. When electric power supply is failed, then the control signal from ECU 17 is stopped so as to allow electromagnetic valve 7 to close automatically, because electromagnetic valve 7 is a normally closed valve.

When brake lever 20 is gripped by the rider as shown in FIG. 3, then master cylinder piston 32 is displaced by the displacement Xa from the default position Xa0. With electromagnetic valve 7 closed, second booster chamber Rb2 hydraulically communicates with second pressurizing chamber Rm2 of master cylinder 3, but is shut off from reservoir tank RES. Accordingly, second pressurizing chamber Rm2 supplies the volume Qm2 (Qm2=A2·Xa) of brake fluid to second booster chamber Rb2.

Booster piston 42 is freely movable as long as input rod 42b of booster piston 42 is out of contact with the contact portion 5a of rotation-translation converter 5, although electric motor 15 is de-energized so that the contact portion 5a is stationary. Since B2=A2, the displacement Xb of booster piston 42 in the positive x-axis direction due to the volume Qm2 is equal to the value Xa.

The displacement Xb (Xb=Xa) of booster piston 42 in the positive x-axis direction causes a decrease in the volumetric capacity of first booster chamber Rb1 by a volume Qb1 (Qb1=B1·Xb). In summary, first booster chamber Rb1 supplies a volume of Q (Q=Qm1+Qb1) of brake fluid, as a sum of the volume Qb1 (Qb1=B1·Xb) and the volume Qm1 (Qm1=A1·Xa) supplied from first pressurizing chamber Rm1, to wheel cylinder 16.

On the assumption of A1=B1 and Xa=Xb, it is obtained that Qm1 is equal to Qb1, and Q=Qm1+Qb1=2Qm1=2(A1·Xa). The volume Q is twice a volume corresponding to the amount of manipulation a of brake lever 20 (displacement Xa of master cylinder piston 32). The function of boosting thus produces an effect of doubling the stroke or displacement of master cylinder 3 (Q=A1·2Xa) so as to increase the rate of increase of wheel cylinder pressure Pw, as under normal operating conditions.

When forces applied to booster piston 42 are in balance, then it satisfies an equation of Pw·B1=Pb2·B2, in no consideration of the elastic forces of springs 43 and 44, where Pb2 represents the internal pressure of second booster chamber Rb2 of booster cylinder 4. This yields Pb2=Pw·B1/B2. Since the internal pressure of second pressurizing chamber Rm2 of master cylinder 3 is equal to that of second booster chamber Rb2 of booster cylinder 4, the internal pressure of second pressurizing chamber Rm2 is equal to the wheel cylinder pressure Pw on the assumption of B1=B2.

In summary, master cylinder piston 32 is subject to a force of Fm1 (Fm1=Pw·A1) acting in the negative x-axis direction from first pressurizing chamber Rm1 and a force of Fm2 (Fm2=Pw·A2) acting in the negative x-axis direction from second pressurizing chamber Rm2. Accordingly, brake lever 20 is subject to a force of Fm (Fm=Fm1+Fm2=2(Pw·A1)) acting from master cylinder piston 32 in the negative x-axis direction. In this way, when electric motor 15 is failed, the feedback force applied to brake lever 20 is twice the force applied under the normal operating conditions, although the same wheel cylinder pressure Pw is obtained with respect to the same stroke of brake lever 20. In other words, when electric motor 15 is failed, brake apparatus 1 requires the same stroke α of brake lever 20 and twice the gripping force of brake lever 20, in order to obtain the same wheel cylinder pressure Pw, as compared to normal operating conditions.

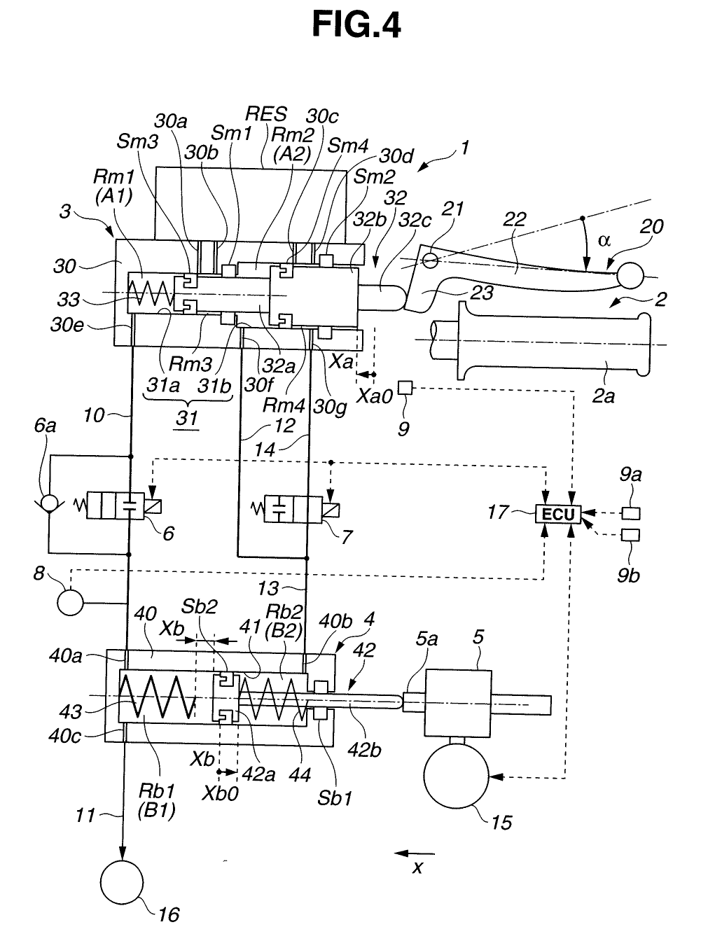

FIG. 4 schematically shows an operation of brake apparatus 1 under condition that the function of ABS is active. In FIG. 4, when the function of boosting is active and electromagnetic valve 7 is opened, the function of ABS is implemented by reducing the wheel cylinder pressure Pw by controlling the electric motor 15.

As shown in FIG. 2, when brake lever 20 is manipulated by the amount of manipulation a, then master cylinder piston 32 is displaced in the positive x-axis direction by the displacement Xa, electromagnetic valve 7 is opened, and electric motor 15 is controlled to rotate in the normal rotational direction. As a result, the volume Q (Q=2(A1·Xa)) is supplied to wheel cylinder 16 so as to produce the wheel cylinder pressure Pw.

On the other hand, ECU 17 constantly computes a vehicle speed on the basis of the values measured by wheel speed sensors 9a and 9b, for example, on the basis of the higher one of the measured values, and computes an amount of slip of the front wheel relative to a road surface on the basis of the computed vehicle speed and the measured front wheel speed. ECU 17 judges whether or not the amount of slip of the front wheel is above a predetermined threshold value. When having judged that the amount of slip of the front wheel is above the predetermined threshold value, then ECU 17 reduces the wheel cylinder pressure by energizing the electromagnetic valve 6 so as to close the electromagnetic valve 6 and allowing the electric motor 15 to rotate in the reverse rotational direction by a suitable amount.

The reverse rotation of electric motor 15 causes the contact portion 5a of rotation-translation converter 5 to move in the negative x-axis direction, for example, maximally, and thereby allows booster piston 42 to move in the negative x-axis direction. The internal pressure of second booster chamber Rb2 is equal to the atmospheric pressure, because electromagnetic valve 7 is opened. Since electromagnetic valve 6 is closed and the internal pressure of first booster chamber Rb1 is equal to the wheel cylinder pressure Pw, booster piston 42 is subject to a force of Fb1 (Fb1=Pw·B1) in the negative x-axis direction acting from first booster chamber Rb1.

Under the force Fb1, booster piston 42 is displaced to a position on the negative x side of the default position Xb0 where the force Fb1 is cancelled by the biasing force of the soft spring 44. The negative x side longitudinal end of the hard spring 43 is adapted to be in contact with the longitudinal end of slider 42a, but is not fixed to slider 42a. Accordingly, when booster piston 42 is in the above position on the negative x side, then booster piston 42 is subject to the weak biasing force of spring 44 but no force acting from spring 43. As a result, the wheel cylinder pressure Pw decreases to such a level that the wheel cylinder pressure Pw and the spring 44 are brought into balance.

While the function of ABS is active, electromagnetic valve 6 is closed, as described above. Accordingly, master cylinder piston 32 is not further displaced in the positive x-axis direction, as long as the internal pressure of first pressurizing chamber Rm1 is above the wheel cylinder pressure Pw. Brake lever 20 is thus subject to a feedback force according to the internal pressure of first pressurizing chamber Rm1. When the internal pressure of first pressurizing chamber Rm1 decreases to be below the wheel cylinder pressure Pw (equal to the internal pressure of first booster chamber Rb1), for example, in accordance with release of brake lever 20, then the brake fluid flows back from wheel cylinder 16 to first pressurizing chamber Rm1 of master cylinder 3 through first booster chamber Rb1 of booster cylinder 4 and check valve 6a, reducing the wheel cylinder pressure Pw.

When having judged that the front wheel exits the state of slip so that the amount of slip of the front wheel is below the predetermined threshold value after the reduction of the wheel cylinder pressure Pw by the reverse rotation of electric motor 15, then ECU 17 allows booster piston 42 to move back in the positive x-axis direction so as to satisfy Xb=Xa, by allowing the electric motor 15 to rotate again in the normal rotational direction. Accordingly, the wheel cylinder pressure Pw increases again according to the volume Q (Q=2(A1·Xa)) of brake fluid, as before the start of the function of ABS. At this time, ECU 17 checks whether or not the front wheel is in a state of slip. When having judged that the front wheel is not in a state of slip, then ECU 17 allows electromagnetic valve 6 to open. ECU 17 thus terminates the function of ABS, and starts to implement the function of boosting.

When having judged that the front wheel is in a state of slip before booster piston 42 reaches the above position (Xb=Xa), then ECU 17 keeps electromagnetic valve 6 closed, and allows electric motor 15 to rotate in the reverse direction again, so as to allow booster piston 42 to move in the negative x-axis direction. ECU 17 thus repeats the process of depressurization of wheel cylinder pressure Pw, detection of recovery from slip state, and re-pressurization of wheel cylinder pressure Pw, until the front wheel exits the state of slip.

### COMPARISON TO COMPARATIVE EXAMPLES

As for four-wheeled vehicles, it is preferable for a two-wheeled vehicle that the vehicle includes a brake apparatus capable of implementing a function of ABS in order to prevent the vehicle from toppling due to wheel lock, and allow the vehicle to stop in short braking distances. On the other hand, in contrast to most four-wheeled vehicles, some vehicles such as two-wheeled vehicles include a brake system in which a front brake is operated in accordance with hand manipulation of a brake lever provided at a right handle and a rear brake is operated in accordance with foot manipulation of a right brake pedal.

Since such brake levers are designed and adapted for hands, the brake levers are generally constructed to receive a limited amount of work based on a limited manipulating force and a limited stroke, and allow brake fluid to be supplied to in accordance with the limited amount of work. Among others, limitation on the stroke of a brake lever, and limitation on the stroke of a master cylinder that is operated in accordance with manipulation of the brake lever, are relatively significant. Even when a front wheel is provided with a brake pad of a high coefficient of friction such as a value of 0.5, limitation on the stroke of a brake lever is still disadvantageous for producing higher wheel cylinder pressures. Accordingly, it is preferable that a brake apparatus for a front wheel is provided with a function of boosting or a function of producing an apparent assist stroke of a master cylinder (or an apparent assist volume of brake fluid) by supplying an equivalent amount of brake fluid to a wheel cylinder independently of the master cylinder, in addition to the function of ABS.

### First Comparative Example

Japanese Patent Application Publication No. 2006-123767 corresponding to European Patent Application Publication No. 1652745 discloses a brake-by-wire (BBW) system in which a master cylinder is hydraulically separated from a brake caliper, and provided with a stroke simulator for setting a relationship between a gripping force of a brake lever and a stroke of the brake lever, and a hydraulic unit is electrically controlled to produce a brake fluid pressure in accordance with the stroke of the brake lever or the gripping force of the brake lever. The BBW system is capable of implementing a function of boosting by electrically controlling the brake fluid pressure with no mechanical restrictions imposed by manipulation of the brake lever. The BBW system may be provided with an ABS modulator arranged upstream of a brake caliper, in order to implement a function of ABS.

Under normal operating conditions, the BBW system allows fluid communication between the master cylinder and the stroke simulator so as to allow the stroke of the master cylinder. When an electric actuator for the hydraulic unit is failed, then the BBW system hydraulically separates the master cylinder from the stroke simulator, and allows the master cylinder to supply brake fluid directly to the brake caliper.

The BBW system however has at least the following disadvantages. First, the BBW system cannot allow a rider to directly receive a feedback corresponding to an actual braking force, because the brake lever is subject to no force produced by the brake fluid pressure while the BBW system is normal. The BBW system cannot also allow the rider to sense a variation of the stroke of the brake lever resulting from a variation of temperature, for example, when the volumetric capacity of the brake caliper increases due to temperature rise.

Second, when the amplification factor is set large so that the volume of brake fluid absorbed by the stroke simulator is much smaller than that supplied to the brake caliper, and a failure occurs so that the BBW system hydraulically separates the master cylinder from the stroke simulator, and allows the master cylinder to supply brake fluid directly to the brake caliper, then the BBW system requires a much longer stroke of the master cylinder or the brake lever for attaining a desired brake fluid pressure, because the BBW system produces no amount of assist for stroke of the master cylinder or no apparent assist stroke of the master cylinder. Accordingly, the brake lever may reach the stroke end, although an adequate volume of brake fluid is not yet supplied to the brake caliper. This causes a decrease in a maximum possible brake fluid pressure, and causes a possibility that a desired braking force is not achieved.

In contrast, brake apparatus 1 according to the first embodiment allows a feedback force proportional to the brake fluid pressure (wheel cylinder pressure Pw) to be transmitted to a rider through brake lever 20, even while the function of boosting is carried out with the electric actuator (or electric motor 15). This allows the rider to sense the braking force according to the feedback force applied to brake lever 20, and sense a variation of the stroke of the brake lever resulting from a variation of temperature.

When the electric actuator (or electric motor 15) is failed, then booster piston 42 is displaced by the manipulating force of brake lever 20 so as to produce an amount of assist for stroke of master cylinder 3 or an apparent assist stroke of master cylinder 3. The required amount of stroke of brake lever 20 remains within an allowable level. This prevents the maximum possible value of wheel cylinder pressure Pw from decreasing, and allows brake apparatus 1 to reliably attain desired braking forces.

The capacity of electric motor 15 may be smaller than that of an electric motor used in the BBW system according to the first comparative example, because both of the work of manipulation of brake lever 20 and the work of electric motor 15 contribute to pressurization of wheel cylinder 16 in the function of boosting in the first embodiment in contrast to the BBW system according to the first comparative example in which only the work of the electric motor contributes to pressurization of the brake caliper in the function of boosting.

### Second Comparative Example

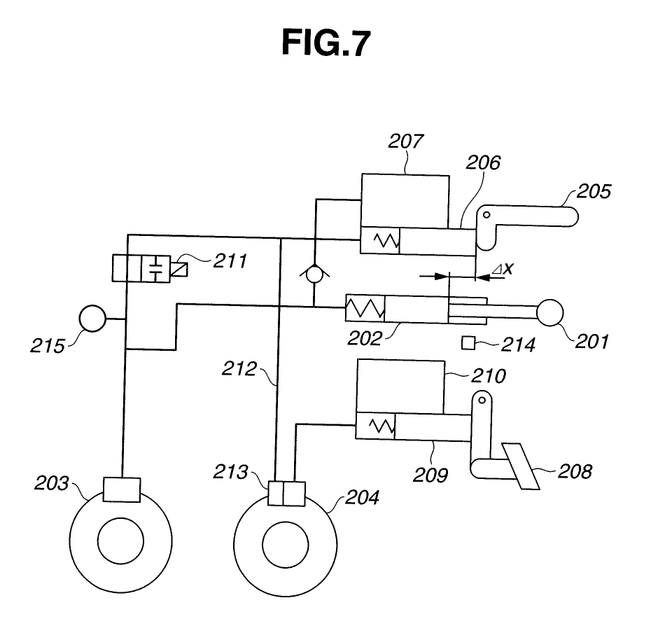

FIG. 7 schematically shows a brake apparatus according to a second comparative example. This brake apparatus includes a section for a front wheel 203, and a section for a rear wheel 204. The section for front wheel 203 includes a brake lever 205, a master cylinder 206, a reservoir tank 207, an electric motor 201 and a booster cylinder 202. The section for rear wheel 204 includes a brake pedal 208, a master cylinder 209, and a reservoir tank 210. The brake apparatus is configured to implement a function of boosting and a function of ABS for front wheel 203 by actuating the booster cylinder 202 by electric motor 201. When the function of boosting is normally active, brake lever 205 is subject to a feedback force resulting from a brake fluid pressure, and allows a rider to sense a braking force in accordance with the feedback force.

The function of boosting is specifically implemented as follows. Brake lever 205 transmits a thrust to master cylinder 206 so as to generate a hydraulic pressure in master cylinder 206. The generated hydraulic pressure in master cylinder 206 is transmitted to a caliper of front wheel 203. On the other hand, booster cylinder 202 is pressurized by rotation of electric motor 201 in a normal rotational direction, to generate a hydraulic pressure. The generated hydraulic pressure in booster cylinder 202 is also supplied to the caliper of front wheel 203, in addition to the generated hydraulic pressure in master cylinder 206.

A displacement sensor 214 is provided for master cylinder 206 and booster cylinder 202. The pressure-receiving area of master cylinder 206 is set equal to that of booster cylinder 202. Electric motor 201 is controlled so as to conform the piston stroke of booster cylinder 202 to that of master cylinder 206, i.e. so as to keep the relative piston displacement Δx equal to zero. Accordingly, twice the volume of brake fluid supplied from master cylinder 206 is supplied to the caliper of front wheel 203. In this way, as compared to a reference brake system provided with no function of boosting, the pressure-receiving area of master cylinder 206 may be half that of the reference brake system, in order to supply a certain volume of brake fluid or a certain wheel cylinder pressure to the brake caliper in response to a certain amount of manipulation of brake lever 205, as in the first embodiment.

The brake apparatus according to the second comparative example implements the function of ABS as follows. When front wheel 203 is in a state of slip, then a normally open electromagnetic valve 211 hydraulically arranged between master cylinder 206 and the caliper of front wheel 203 is closed. Accordingly, booster cylinder 202 and the front caliper constitute a closed hydraulic system. The brake fluid pressure for front wheel 203 is reduced by allowing the electric motor 201 to rotate in a reverse rotational direction so as to move back the piston of booster cylinder 202. After front wheel 203 recovers a gripping force due to the reduction of the brake fluid pressure, the brake fluid pressure is increased again by allowing the electric motor 201 to rotate in the normal rotational direction so as to conform the relative piston displacement Δx to zero.

The hydraulic pressure in the caliper of front wheel 203 is monitored by a fluid pressure sensor 215 which is disposed in a line connected between master cylinder 206 and the front caliper.

When brake lever 205 is manipulated, the master cylinder pressure is introduced through a line 212 into an auxiliary wheel cylinder 213 which is provided at the caliper of rear wheel 204. Such a system is referred to as combined brake system.

In this way, the brake apparatus according to the second comparative example is capable of performing the function of boosting and the function of ABS with a simple construction including a single electric motor and a single electromagnetic valve, and producing a desired brake fluid pressure based on a small amount of manipulation of brake lever 205 and a small manipulating force, and producing a feedback force applied to brake lever 205 in accordance with the brake fluid pressure, during the function of boosting.

When electric motor 201 is failed due to disconnection, etc., the required amount of stroke of master cylinder 206 or the required amount of stroke of brake lever 205 for a certain brake fluid pressure are doubled as compared to normal operating conditions. Accordingly, brake lever 205 may reach the stroke end, although an adequate volume of brake fluid is not yet supplied to the brake caliper. This causes a decrease in a maximum possible brake fluid pressure, and causes a possibility that a desired braking force is not achieved, as in the first comparative example. Among others, the brake apparatus according to the second comparative example may confront a problem of shortage of stroke of brake lever 205, because master cylinder 206 supplies brake fluid to both of the front caliper and auxiliary wheel cylinder 213 in response to manipulation of brake lever 205.

In contrast, brake apparatus 1 according to the first embodiment includes master cylinder 3 including two separate pressure chambers (first pressurizing chamber Rm1, second pressurizing chamber Rm2), where one of the pressure chambers (first pressurizing chamber Rm1) is hydraulically connected to wheel cylinder 16 (front caliper), and the other pressure chamber (second pressurizing chamber Rm2) is hydraulically connected to the back pressure chamber (second booster chamber Rb2) of booster cylinder 4.

In the first embodiment, when both of the booster actuator (electric motor 15, etc.) and the electric power system are normal, one of the pressure chambers (first pressurizing chamber Rm1) of master cylinder 3 supplies brake fluid to the front caliper, and the other pressure chamber (second pressurizing chamber Rm2) generates no hydraulic pressure. Booster cylinder 4 driven by electric motor 15 is connected between master cylinder 3 and wheel cylinder 16. The volume of brake fluid supplied from booster cylinder 4 (first booster chamber Rb1) is added to the volume of brake fluid supplied from first pressurizing chamber Rm1.

On the other hand, when at least one of the booster actuator (electric motor 15, etc.) and the electric power system is failed, both of the pressure chambers of master cylinder 3 supply brake fluid to wheel cylinder 16. Thus, the other pressure chamber (second pressurizing chamber Rm2) of master cylinder 3 generates a hydraulic pressure, so as to pressurize the back pressure chamber (second booster chamber Rb2) of booster cylinder 4. Accordingly, booster piston 42 travels so as to add a volume of brake fluid from booster cylinder 4 (first booster chamber Rb1) to the brake fluid supplied from the one pressure chamber (first pressurizing chamber Rm1) of master cylinder 3.

In this way, brake apparatus 1 according to the first embodiment allows operation of booster cylinder 4 according to manipulation of brake lever 20 for supplying brake fluid, even when at least one of the booster actuator (electric motor 15, etc.) and the power supply system is failed. This solves a problem of shortage of stroke of brake lever 20 at the time of failures.

Brake apparatus 1 may be modified or provided with a combined brake system (CBS), as in the second comparative example. Specifically, brake apparatus 1 as modified includes an auxiliary wheel cylinder at a rear caliper, where the auxiliary wheel cylinder is hydraulically connected to fluid passage 10. Brake apparatus 1 as thus modified also prevents or minimizes the problem of shortage of stroke of brake lever 20.

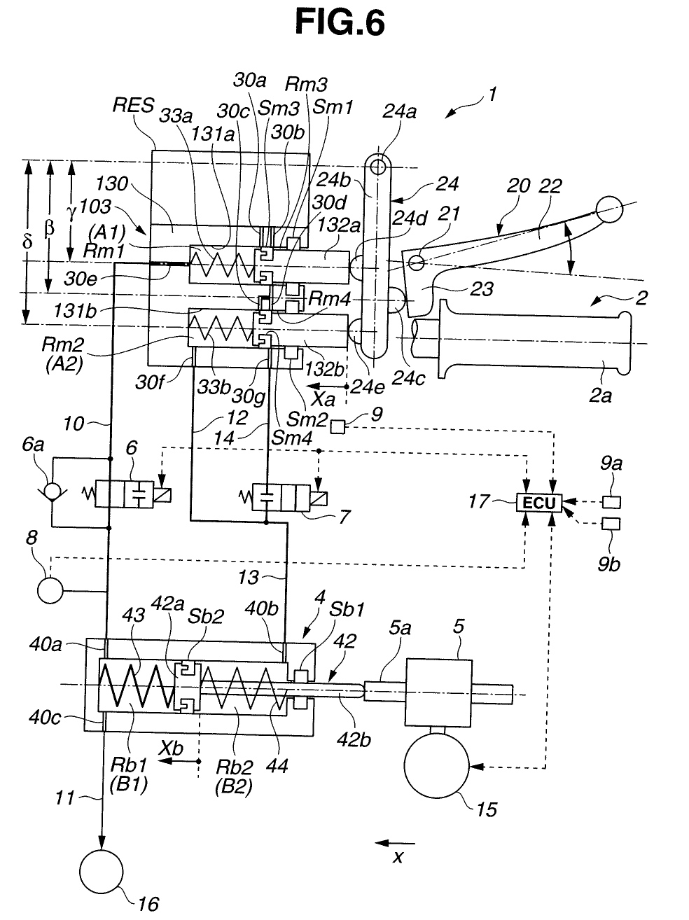

Although the two separate pressure chambers in brake apparatus 1 according to the first embodiment are implemented by master cylinder 3 which includes a stepped cylinder and a stepped piston, master cylinder 3 may be modified or constructed so that a master cylinder includes a pair of cylinders arranged in parallel and a pair of pistons for respective ones of the cylinders adapted to be pressed simultaneously by a brake lever, as shown in FIG. 6 which shows a third embodiment of the present invention described in detail below.

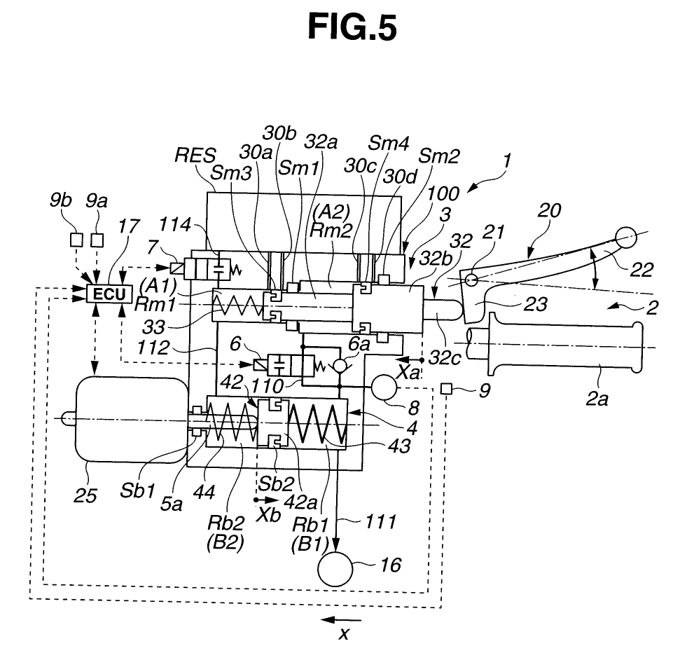

In the first embodiment, the function that the other pressure chamber (second pressurizing chamber Rm2) of master cylinder 3 generates no feedback force or no hydraulic pressure under normal operating conditions, and both of the pressure chambers (first pressurizing chamber Rm1, second pressurizing chamber Rm2) of master cylinder 3 output or supply brake fluid, is implemented by the construction that fluid passages 12 and 13 hydraulically connect second pressurizing chamber Rm2 to second booster chamber Rb2, pressure relief passage 14 hydraulically connects fluid passages 12 and 13 to reservoir tank RES, electromagnetic valve 7 selectively opens or closes pressure relief passage 14, and the configuration that when the function of boosting is normally active, electromagnetic valve 7 is allowed to open so as to allow fluid communication between second pressurizing chamber Rm2 and reservoir tank RES. The function is not so limited, but may be implemented by a construction that pressure relief passage 14 and electromagnetic valve 7 is replaced with another means for absorbing brake fluid or another fluid absorber that is provided in fluid passages 12 and 13 for absorbing the feedback force or hydraulic pressure generated in second pressurizing chamber Rm2, and a configuration that under abnormal operating conditions, fluid passages 12 and 13 are shut off from the fluid absorber.

[Advantageous Effects] Brake apparatus 1 according to the first embodiment produces at least the following advantageous effects <1> to <6>.

<1> The brake apparatus (1) comprises: a master cylinder (3) including: at least one piston (master cylinder piston 32); a first pressure chamber (first pressurizing chamber Rm1) arranged to output brake fluid in accordance with travel (Xa) of the at least one piston (master cylinder piston 32); and a second pressure chamber (second pressurizing chamber Rm2) arranged to output brake fluid in accordance with the travel (Xa) of the at least one piston (master cylinder piston 32); a booster (booster cylinder 4, electric motor 15) including: a booster cylinder (4); a booster piston (42) movably mounted in the booster cylinder (4), the booster piston (42) dividing an internal space (in-cylinder space 41) of the booster cylinder (4) at least into a boost pressure chamber (first booster chamber Rb1) and a back pressure chamber (second booster chamber Rb2); and an electric actuator (electric motor 15, rotation-translation converter 5) arranged to actuate the booster piston (42); a first fluid passage section (fluid passages 10, 11) hydraulically connecting the first pressure chamber (first pressurizing chamber Rm1) of the master cylinder (3) and the boost pressure chamber (first booster chamber Rb1) of the booster cylinder (4) to a wheel cylinder (16, or front caliper); and a second fluid passage section (fluid passages 12, 13, 14) hydraulically connecting the second pressure chamber (second pressurizing chamber Rm2) of the master cylinder (3) to the back pressure chamber (second booster chamber Rb2) of the booster cylinder (4). The brake apparatus (1) is configured so that the boost pressure chamber (first booster chamber Rb1) of the booster cylinder (4) is hydraulically connected between the first pressure chamber (first pressurizing chamber Rm1) of the master cylinder (3) and the wheel cylinder (16). These features implement a function of boosting by producing an amount of assist for stroke of the master cylinder or producing an apparent assist stroke of the master cylinder (3, or brake lever 20) with the electric actuator (electric motor 15, rotation-translation converter 5). The assistance for stroke of the master cylinder (3) can be continued by allowing a manipulating force of the brake lever (20) to keep a volume of brake fluid supplied to the wheel cylinder (16), even when the electric actuator (electric motor 15, rotation-translation converter 5) or a power supply system is failed. This causes no increase in a required amount of manipulation of the brake lever (20), and causes no change in a required range of manipulation of the brake lever (20). Thus, even with the failure, the brake apparatus (1) can produce a sufficient braking force. While the function of boosting is normal and active, the brake lever (20) is subject to a feedback force proportional to a brake fluid pressure (wheel cylinder pressure Pw), allowing a rider to sense a braking force according to the feedback force, and sense a variation of stroke of the brake lever (20) due to temperature variation. Since the manipulating force of the brake lever (20) is used to produce a braking force, the capacity of an electric motor (15) of the electric actuator may be lower than that of the electric motor of the BBW system according to the first comparative example in which an amount of work required for braking is contributed to only by the electric motor.

<2> The brake apparatus (1) is configured so that the second fluid passage section (fluid passages 12, 13, 14) is configured to: prevent the back pressure chamber (second booster chamber Rb2) of the booster cylinder (4) from being pressurized by the brake fluid outputted from the second pressure chamber (second pressurizing chamber Rm2) of the master cylinder (3), in response to a condition that the electric actuator (electric motor 15, rotation-translation converter 5) is normal; and allow the back pressure chamber (second booster chamber Rb2) of the booster cylinder (4) to be pressurized by the brake fluid outputted from the second pressure chamber (second pressurizing chamber Rm2) of the master cylinder (3), in response to a condition that the electric actuator (electric motor 15, rotation-translation converter 5) is failed. When the electric motor (15) is normal, these features are effective for allowing depressurization of the wheel cylinder (16) during operation of the electric motor (15), because the back pressure chamber (second booster chamber Rb2) of the booster cylinder (4) is subject to no hydraulic pressure. On the other hand, when the electric motor (15) is failed, the features are effective for moving the booster piston (42) so as to contract the volumetric capacity of the boost pressure chamber (first booster chamber Rb1) of the booster cylinder (4) even without the electric motor (15), because the back pressure chamber (second booster chamber Rb2) of the booster cylinder (4) is subject to a hydraulic pressure supplied from the second pressure chamber (second pressurizing chamber Rm2) of the master cylinder (3). Thus, the brake apparatus (1) can keep the volume of brake fluid outputted from the boost pressure chamber (first booster chamber Rb1) of the booster cylinder (4), so as to cause no increase in the amount of manipulation of the brake lever (20), and keep constant the range of manipulation of the brake lever (20).

<3> The brake apparatus (1) is configured so that the second fluid passage section (fluid passages 12, 13, 14) includes: a pressure relief passage (14) hydraulically connecting the second pressure chamber (second pressurizing chamber Rm2) of the master cylinder (3) and the back pressure chamber (second booster chamber Rb2) of the booster cylinder (4) to a fluid absorber (reservoir tank RES); and an electromagnetic valve (7) disposed in the pressure relief passage (14), and configured to close in response to a condition that the electric actuator (electric motor 15, rotation-translation converter 5) is failed. When the electric actuator (electric motor 15, rotation-translation converter 5) is failed, the closing operation of the electromagnetic valve (7) is effective for moving the booster piston (42) so as to contract the volumetric capacity of the boost pressure chamber (first booster chamber Rb1) of the booster cylinder (4) even without the electric motor (15), because the back pressure chamber (second booster chamber Rb2) of the booster cylinder (4) is reliably subject to a hydraulic pressure supplied from the second pressure chamber (second pressurizing chamber Rm2) of the master cylinder (3). Thus, the brake apparatus (1) can keep the volume of brake fluid outputted from the boost pressure chamber (first booster chamber Rb1) of the booster cylinder (4), so as to cause no increase in the amount of manipulation of the brake lever (20), and keep constant the range of manipulation of the brake lever (20). The opening operation of the electromagnetic valve (7) serves to allow brake fluid to flow from the back pressure chamber (second booster chamber Rb2) of the booster cylinder (4) so as to allow a function of ABS to be smoothly performed or allow smooth depressurization of the wheel cylinder (16). Thus, the electromagnetic valve (7) serves for both of the function of boosting and the function of ABS by being opened. The brake apparatus (1) is further configured so that the first fluid passage section (fluid passages 10, 11) includes an electromagnetic valve (6) disposed in a fluid passage (10) hydraulically connected between the first pressure chamber (first pressurizing chamber Rm1) of the master cylinder (3) and the boost pressure chamber (first booster chamber Rb1) of the booster cylinder (4), and configured to close in response to a request for depressurization of the wheel cylinder (16). In this way, both of the function of boosting and the function of ABS are implemented by a simple construction including a small number of parts such as the single electric motor (15), and two electromagnetic valves (6, 7). The fluid absorber is not limited to reservoir tank RES, but may be implemented by another means for absorbing brake fluid.

<4> The brake apparatus (1) is configured so that the master cylinder (3) includes a replenishing chamber (Rm4) hydraulically connected to the fluid absorber (reservoir tank RES) for replenishing at least one of the first and second pressure chambers (second pressurizing chamber Rm2) with brake fluid; and the pressure relief passage (14) is hydraulically connected to the fluid absorber (reservoir tank RES) through the replenishing chamber (Rm4) of the master cylinder (3). These features produce at least an advantageous effect that the brake apparatus (1) is composed of a simple hydraulic circuit, because it is unnecessary to extend the pressure relief passage (14) from the back pressure chamber (second booster chamber Rb2) of the booster cylinder (4) to the fluid absorber (reservoir tank RES).

<5> The brake apparatus (1) is configured so that the electric actuator (electric motor 15, rotation-translation converter 5) is configured to move the booster piston (42) so as to expand the back pressure chamber (second booster chamber Rb2) by a volume (Qb2) substantially equal to a volume of the brake fluid (Qm2) outputted from the second pressure chamber (second pressurizing chamber Rm2) of the master cylinder (3), in response to a condition that the electric actuator (electric motor 15, rotation-translation converter 5) is normal. These features produce at least an advantageous effect that the brake apparatus (1) is composed of a simple hydraulic circuit, because it is unnecessary to drain an excess amount of brake fluid from the second pressure chamber (second pressurizing chamber Rm2) of the master cylinder (3) to the fluid absorber (reservoir tank RES) when the electric actuator (electric motor 15, rotation-translation converter 5) is normal.

<6> The brake apparatus (1) is configured so that the master cylinder (3) includes an in-cylinder space (31) accommodating the piston (master cylinder piston 32) of the master cylinder (3); the in-cylinder space (31) includes a small-diameter in-cylinder space (31a) and a large-diameter in-cylinder space (31b); and the piston (master cylinder piston 32) of the master cylinder (3) includes a small-diameter portion (32a) mounted in the small-diameter in-cylinder space (31a) and a large-diameter portion (32b) mounted in the large-diameter in-cylinder space (31b), defining the first and second pressure chambers (first pressurizing chamber Rm1, second pressurizing chamber Rm2) in the in-cylinder space (31). These features produce at least an advantageous effect that the master cylinder (3) in which the first and second pressure chambers (first pressurizing chamber Rm1, second pressurizing chamber Rm2) are arranged is constructed with a short total longitudinal size.

[Second Embodiment] FIG. 5 schematically shows a configuration of a brake apparatus according to a second embodiment of the present invention. Brake apparatus 1 according to the second embodiment is created by modifying the brake apparatus 1 according to the first embodiment as follows. In master cylinder 3, first pressurizing chamber Rm1 is adapted to implement the function of second pressurizing chamber Rm2 of the first embodiment, and second pressurizing chamber Rm2 is adapted to implement the function of first pressurizing chamber Rm1 of the first embodiment. Brake apparatus 1 includes a hydraulic unit or block 100 in which master cylinder 3 and booster cylinder 4 are arranged. Accordingly, the piping for fluid passages 10, 12 and 13 and pressure relief passage 14 in the first embodiment is replaced with fluid passages 110 and 112 and a pressure relief passage 114 formed in hydraulic unit 100. Electromagnetic valves 6 and 7 and check valve 6a, which are provided in the piping in the first embodiment, are arranged within hydraulic unit 100.

Specifically, first pressurizing chamber Rm1 of master cylinder 3 is hydraulically connected to second booster chamber Rb2 of booster cylinder 4 through fluid passage 112, and hydraulically connected to reservoir tank RES through pressure relief passage 114. Pressure relief passage 114 is provided with normally closed electromagnetic valve 7. Second pressurizing chamber Rm2 of master cylinder 3 is hydraulically connected to first booster chamber Rb1 of booster cylinder 4 through fluid passage 110. Fluid passage 110 is provided with normally open electromagnetic valve 6. Check valve 6a is provided in parallel to electromagnetic valve 6 for allowing brake fluid to flow from first booster chamber Rb1 to second pressurizing chamber Rm2, and preventing brake fluid from inversely flowing from second pressurizing chamber Rm2 to first booster chamber Rb1. Fluid pressure sensor 8 is disposed outside of hydraulic unit 100 for measuring the wheel cylinder pressure Pw in a passage section connected between check valve 6a and first booster chamber Rb1.

Electric motor 15 in the first embodiment is replaced with an electric motor 25 within which rotation-translation converter 5 is arranged. Electric motor 25 is fixedly mounted to hydraulic unit 100 to form an integrated unit. The contact portion 5a of rotation-translation converter 5 extends out of electric motor 25, and includes a semispherical negative x side longitudinal end adapted to be in contact with the positive x side longitudinal end of booster piston 42. Booster piston 42 according to the second embodiment is a free piston including slider 42a but no input rod 42b. When electric motor 25 rotates in a normal rotational direction, then the contact portion 5a of rotation-translation converter 5 moves in the negative x-axis direction, presses the slider 42a, and thereby allows booster piston 42 to travel in the negative x-axis direction.

Except the foregoing construction, brake apparatus 1 according to the second embodiment has a construction similar to that of brake apparatus 1 according to the first embodiment.

<Operation of Brake Apparatus in Second Embodiment> As in the first embodiment, the ratios between the pressure-receiving areas A1, A2, B1 and B2 are set so as to suitably adjust an amount of assist for stroke of master cylinder 3 or the ratio of an apparent assist stroke or an apparent amplified stroke of master cylinder 3 to an actual stroke of master cylinder 3, for normal operating conditions, and for failed operating conditions. In the second embodiment, the pressure-receiving areas B1 and B2 of first and second booster chambers Rb1 and Rb2 of booster cylinder 4 are set larger than the pressure-receiving areas A1 and A2 of first and second pressurizing chambers Rm1 and Rm2 of master cylinder 3, so as to shorten an amount of stroke of booster piston 42 required for a certain wheel cylinder pressure Pw. This allows to reduce the size of booster cylinder 4 in the x-axis direction.

The pressure-receiving areas may be set as A1=A2=½·B1=½·B2, for example. Electric motor 25 is controlled so as to maintain a relationship of Xb=½·Xa. Specifically, when master cylinder piston 32 is displaced in the positive x-axis direction by a displacement of Xa, then booster piston 42 is displaced in the negative x-axis direction by a displacement of Xb (Xb=½·Xa). This setting provides an amplification factor of 2. When electric motor 25 is normal, electromagnetic valve 7 is opened constantly.

At this time, first booster chamber Rb1 supplies wheel cylinder 16 with a volume Q (Q=Qm2+Qb1) of brake fluid, as a sum of a volume Qm2 (Qm2=A2·Xa) of brake fluid supplied from second pressurizing chamber Rm2 to first booster chamber Rb1 and a volume Qb1 (Qb1=B1·Xb) of brake fluid by which the volumetric capacity of first booster chamber Rb1 is reduced. On the assumption of A2= 1/2·B1 and Xa=2Xb, it is obtained that Qm2 is equal to Qb1, and Q=Qm2+Qb1=2Qm2=2(A2·Xa). In this way, the volume Q is twice the volume corresponding to the amount of manipulation a of brake lever 20 (displacement Xa of master cylinder piston 32). In other words, the function of boosting produces an effect of doubling the stroke or displacement of master cylinder 3 (Q=A1·2Xa) so as to increase the rate of increase of wheel cylinder pressure Pw.

Except the foregoing description, brake apparatus 1 according to the second embodiment operates as in the first embodiment. Also, when electric motor 25 is failed or when the function of ABS is active, brake apparatus 1 according to the second embodiment operates as in the first embodiment. According to the second embodiment, the arrangement of both of master cylinder 3 and booster cylinder 4 within hydraulic unit 100 allows the brake apparatus 1 to have a compact outside shape.

[Third Embodiment] FIG. 6 schematically shows a configuration of a brake apparatus according to a third embodiment of the present invention. Brake apparatus 1 according to the third embodiment is created by modifying the brake apparatus 1 according to the first embodiment as follows. Master cylinder 3 in the form of a combination of a stepped cylinder and a stepped piston in the first embodiment is replaced with a master cylinder 103. Master cylinder 103 includes a first in-cylinder space 131a and a second in-cylinder space 131b which are arranged in parallel. The stroke of brake lever 20 is transmitted to a first master cylinder piston 132a and a second master cylinder piston 132b through a link 24.

Specifically, first in-cylinder space 131a and second in-cylinder space 131b are arranged in parallel in a cylinder housing 130, and have openings in the negative x side longitudinal end surface of cylinder housing 130. First master cylinder piston 132a and second master cylinder piston 132b are cylindrically formed and mounted in first in-cylinder space 131a and second in-cylinder space 131b, respectively. In the third embodiment, first master cylinder piston 132a serves as the small-diameter portion 32a of master cylinder piston 32 of the first embodiment, and second master cylinder piston 132b serves as the large-diameter portion 32b of master cylinder piston 32 of the first embodiment.

First in-cylinder space 131a and first master cylinder piston 132a define first pressurizing chamber Rm1, and second in-cylinder space 131b and second master cylinder piston 132b define second pressurizing chamber Rm2. A return spring 33a is disposed in first pressurizing chamber Rm1, and a return spring 33b is disposed in second pressurizing chamber Rm2. In FIG. 6, brake lever 20 is in a state of no manipulation, and fluid passages 30c and 30d hydraulically connects second in-cylinder space 131b to reservoir tank RES.

Link 24 includes a pivot 24a, and an arm 24b which is supported to swing about pivot 24a and move generally in the x-axis direction. Arm 24b includes contact portions 24d and 24e which project into semispherical shapes from the positive x side of arm 24b. Contact portions 24d and 24e are adapted to be in contact with the negative x side end surfaces of first master cylinder piston 132a and second master cylinder piston 132b. Arm 24b also includes a contact portion 24c which projects into a semispherical shape from the negative x side of arm 24b. Contact portion 24c is adapted to be in contact with the contact portion 23 of brake lever 20. Link 24 may be constructed in another form to transmit a force between brake lever 20 and a set of first and second master cylinder pistons 132a and 132b.

Except the foregoing construction, brake apparatus 1 according to the third embodiment has a construction similar to that of brake apparatus 1 according to the first embodiment.

<Operation of Brake Apparatus in Third Embodiment> Brake apparatus 1 according to the third embodiment operates as follows. When brake lever 20 is gripped or manipulated, then the contact portion 23 of brake lever 20 presses the arm 24b in the positive x-axis direction through contact portion 24c. Accordingly, arm 24b swings about pivot 24a, and moves generally in the positive x-axis direction. Arm 24b presses first and second master cylinder pistons 132a and 132b in the positive x-axis direction through contact portions 24d and 24e, so as to allow first and second master cylinder pistons 132a and 132b to travel in the positive x-axis direction. Naturally, the amounts of stroke of first and second master cylinder pistons 132a and 132b corresponding to a certain amount of manipulation of brake lever 20 are nearly equal to each other. The pressure-receiving areas A1 and A2 of first pressurizing chamber Rm1 and second pressurizing chamber Rm2 is set as A1=A2, as in the first embodiment. This setting produces similar advantageous effects as in the first embodiment.

The parallel arrangement of in-cylinder spaces of master cylinder 103 is advantageous in processing, and mountability, as compared to the first embodiment or the second embodiment.

As shown in FIG. 6, in link 24, a lever ratio of γ/β is smaller than a lever ratio of δ/β, where β represents a distance between pivot 24a as a fulcrum and contact portion 24c as a point of effort, y represents a distance between pivot 24a as a fulcrum and contact portion 24d as a point of application for first master cylinder piston 132a, and δ represents a distance between pivot 24a as a fulcrum and contact portion 24e as a point of application for second master cylinder piston 132b. The difference between the lever ratios means that the force pressing the first master cylinder piston 132a is constantly larger than the force pressing the second master cylinder piston 132b under manipulation of brake lever 20. The relationship that the lever ratio of γ/β is smaller than the lever ratio of δ/β is unchanged wherever contact portion 24c as a point of effort is located.

Under normal operating conditions where electric motor 15 is normally controlled to implement the function of boosting, the internal pressure of second pressurizing chamber Rm2 is equal to the atmospheric pressure, and the internal pressure of first pressurizing chamber Rm1 is equal to the wheel cylinder pressure Pw. Accordingly, the force Fm applied to brake lever 20 is contributed to only by the first master cylinder piston 132a (Fm=Pw·A1). As a result, the gripping force of brake lever 20 against the force Fm is relatively small due to the difference between the lever ratios. The wheel cylinder pressure Pw can be generated by a smaller gripping force of brake lever 20, as compared to the first embodiment or the second embodiment.

[Modifications] The brake apparatuses according to the present embodiments may be further modified as follows.

Although the booster is implemented by a mechanism in which the output torque of electric motor 15 or 25 are mechanically transmitted to booster piston 42 so as to allow booster piston 42 to travel in in-cylinder space 41 in the first, second and third embodiments, the booster may be differently implemented by another form using an electric motor.

In the description of the first embodiment, the equation of A1=A2=B1=B2 is assumed, where A1 represents a pressure-receiving area of first pressurizing chamber Rm1, A2 represents a pressure-receiving area of second pressurizing chamber Rm2, B1 represents a pressure-receiving area of first booster chamber Rb1 of booster cylinder 4, and B2 represents a pressure-receiving area of second booster chamber Rb2. Also, the equation of Xb=Xa is assumed for the function of boosting, where Xa represents a stroke of master cylinder 3, and Xb represents a stroke of booster cylinder 4. This setting is however not so limited, and may be arbitrarily set so as to suitably adjust the ratio of the apparent assist stroke or the apparent amplified stroke of master cylinder 3 to the actual stroke of master cylinder 3 for normal operating conditions (or adjustment of the amplification factor), and for failed operating conditions (or adjustment of characteristics of stroke). The setting may be arbitrarily set also in the second and third embodiments.

For example, brake apparatus 1 may include a sensor for measuring the displacement Xb of booster piston 42, and be configured to control the displacement Xb with a feedback of the measured position of booster piston 42 so as to achieve a desired characteristic of the wheel cylinder pressure Pw with respect to the displacement Xa of master cylinder 3, where the ratio of the apparent assist stroke to the actual stroke is varied accordingly.

Although brake apparatus 1 is applied to a two-wheeled vehicle in the first, second and third embodiments, brake apparatus 1 may be applied to another type vehicle such as a four-wheeled vehicle.

This application is based on a prior Japanese Patent Application No. 2007-198737 filed on Jul. 31, 2007. The entire contents of this Japanese Patent Application No. 2007-198737 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A brake apparatus comprising:
a master cylinder including:
at least one piston;
a first pressure chamber arranged to output brake fluid in accordance with travel of the at least one piston; and
a second pressure chamber arranged to output brake fluid in accordance with the travel of the at least one piston;
a booster including:
a booster cylinder;
a booster piston movably mounted in the booster cylinder, the booster piston dividing an internal space of the booster cylinder at least into a boost pressure chamber and a back pressure chamber; and
an electric actuator arranged to actuate the booster piston;
a first fluid passage section hydraulically connecting the first pressure chamber of the master cylinder and the boost pressure chamber of the booster cylinder to a wheel cylinder; and
a second fluid passage section hydraulically connecting the second pressure chamber of the master cylinder to the back pressure chamber of the booster cylinder.

2. The brake apparatus as claimed in claim 1, wherein the boost pressure chamber of the booster cylinder is hydraulically connected between the first pressure chamber of the master cylinder and the wheel cylinder.

3. The brake apparatus as claimed in claim 1, wherein the second fluid passage section is configured to:
prevent the back pressure chamber of the booster cylinder from being pressurized by the brake fluid outputted from the second pressure chamber of the master cylinder, in response to a condition that the electric actuator is normal; and
allow the back pressure chamber of the booster cylinder to be pressurized by the brake fluid outputted from the second pressure chamber of the master cylinder, in response to a condition that the electric actuator is failed.

4. The brake apparatus as claimed in claim 3, wherein the second fluid passage section includes:
a pressure relief passage hydraulically connecting the second pressure chamber of the master cylinder and the back pressure chamber of the booster cylinder to a fluid absorber; and
an electromagnetic valve disposed in the pressure relief passage, and configured to close in response to a condition that the electric actuator is failed.

5. The brake apparatus as claimed in claim 4, wherein:
the master cylinder includes a replenishing chamber hydraulically connected to the fluid absorber for replenishing at least one of the first and second pressure chambers with brake fluid; and
the pressure relief passage is hydraulically connected to the fluid absorber through the replenishing chamber of the master cylinder.

6. The brake apparatus as claimed in claim 3, wherein the electric actuator is configured to move the booster piston so as to expand the back pressure chamber by a volume substantially equal to a volume of the brake fluid outputted from the second pressure chamber of the master cylinder, in response to a condition that the electric actuator is normal.

7. The brake apparatus as claimed in claim 3, wherein:
the master cylinder includes an in-cylinder space accommodating the piston of the master cylinder;
the in-cylinder space includes a small-diameter in-cylinder space and a large-diameter in-cylinder space; and
the piston of the master cylinder includes a small-diameter portion mounted in the small-diameter in-cylinder space and a large-diameter portion mounted in the large-diameter in-cylinder space, defining the first and second pressure chambers in the in-cylinder space.

8. The brake apparatus as claimed in claim 3, wherein the master cylinder and the booster are arranged within a hydraulic unit.

9. The brake apparatus as claimed in claim 3, wherein:
the master cylinder includes:
a first in-cylinder space; and
a second in-cylinder space disposed in parallel to the first in-cylinder space; and
the at least one piston of the master cylinder includes:
a first piston mounted in the first in-cylinder space, the first piston defining the first pressure chamber in the first in-cylinder space; and
a second piston mounted in the second in-cylinder space, the second piston defining the second pressure chamber in the second in-cylinder space.

10. The brake apparatus as claimed in claim 3, wherein the first fluid passage section includes an electromagnetic valve disposed in a fluid passage hydraulically connected between the first pressure chamber of the master cylinder and the boost pressure chamber of the booster cylinder, and configured to close in response to a request for depressurization of the wheel cylinder.

11. The brake apparatus as claimed in claim 1, wherein the second fluid passage section includes:
a pressure relief passage hydraulically connecting the second pressure chamber of the master cylinder and the back pressure chamber of the booster cylinder to a fluid absorber; and
an electromagnetic valve disposed in the pressure relief passage, and configured to close in response to a condition that the electric actuator is failed.

12. The brake apparatus as claimed in claim 1, wherein the electric actuator is configured to move the booster piston so as to expand the back pressure chamber by a volume substantially equal to a volume of the brake fluid outputted from the second pressure chamber of the master cylinder, in response to a condition that the electric actuator is normal.

13. The brake apparatus as claimed in claim 1, wherein:
the master cylinder includes an in-cylinder space accommodating the piston of the master cylinder;
the in-cylinder space includes a small-diameter in-cylinder space and a large-diameter in-cylinder space; and
the piston of the master cylinder includes a small-diameter portion mounted in the small-diameter in-cylinder space and a large-diameter portion mounted in the large-diameter in-cylinder space, defining the first and second pressure chambers in the in-cylinder space.

14. The brake apparatus as claimed in claim 1, wherein the master cylinder and the booster are arranged within a hydraulic unit.

15. The brake apparatus as claimed in claim 1, wherein:
the master cylinder includes:
a first in-cylinder space; and
a second in-cylinder space disposed in parallel to the first in-cylinder space; and
the at least one piston of the master cylinder includes:
a first piston mounted in the first in-cylinder space, the first piston defining the first pressure chamber in the first in-cylinder space; and
a second piston mounted in the second in-cylinder space, the second piston defining the second pressure chamber in the second in-cylinder space.

16. The brake apparatus as claimed in claim 15, further comprising a link arranged to swing about a pivot in accordance with manipulation of an input device so as to press the first and second pistons in one direction toward the first and second pressure chambers, the link including:
a first contact portion through which the link is arranged to press the first piston; and
a second contact portion through which the link is arranged to press the second piston, wherein the first contact portion is located at a shorter distance from the pivot than the second contact portion. (J15)

17. The brake apparatus as claimed in claim 1, wherein the first fluid passage section includes an electromagnetic valve disposed in a fluid passage hydraulically connected between the first pressure chamber of the master cylinder and the boost pressure chamber of the booster cylinder, and configured to close in response to a request for depressurization of the wheel cylinder.

18. A brake apparatus comprising:
a master cylinder including:
a first pressure chamber arranged to output brake fluid in accordance with manipulation of an input device, and hydraulically connected to a wheel cylinder; and
a second pressure chamber arranged to output brake fluid in accordance with the manipulation of the input device; and
a booster including:
a booster cylinder;
a booster piston movably mounted in the booster cylinder, the booster piston dividing an internal space of the booster cylinder at least into a boost pressure chamber and a back pressure chamber, the boost pressure chamber being hydraulically connected to the wheel cylinder, the back pressure chamber being hydraulically connected to the second pressure chamber; and
an electric actuator arranged to actuate the booster piston.

19. The brake apparatus as claimed in claim 18, wherein the boost pressure chamber of the booster cylinder is hydraulically connected between the first pressure chamber of the master cylinder and the wheel cylinder.

20. The brake apparatus as claimed in claim 18, wherein:
the back pressure chamber of the booster cylinder is prevented from being pressurized by the brake fluid outputted from the second pressure chamber of the master cylinder, in response to a condition that the electric actuator is normal; and
the back pressure chamber of the booster cylinder is allowed to be pressurized by the brake fluid outputted from the second pressure chamber of the master cylinder, in response to a condition that the electric actuator is failed.

21. The brake apparatus as claimed in claim 20, further comprising:
a pressure relief passage hydraulically connecting the second pressure chamber of the master cylinder and the back pressure chamber of the booster cylinder to a reservoir; and
an electromagnetic valve disposed in the pressure relief passage, and configured to close in response to a condition that the electric actuator is failed.

22. The brake apparatus as claimed in claim 18, further comprising:
a pressure relief passage hydraulically connecting the second pressure chamber of the master cylinder and the back pressure chamber of the booster cylinder to a reservoir; and
an electromagnetic valve disposed in the pressure relief passage, and configured to close in response to a condition that the electric actuator is failed.
